(19) United States
(12) Patent Application Publication
(10) Pub. No.: US 2025/0129211 A1
(43) Pub. Date: Apr. 24, 2025

(54) THERMALLY RESISTANT POLYAMIDE

(71) Applicant: SOLVAY SPECIALTY POLYMERS USA, LLC, Alpharetta, GA (US)

(72) Inventors: Joel Flores, Alpharetta, GA (US); Stéphane Joel, Saint-Genis-Laval (FR); Clay Plavcan, Cumming, GA (US)

(73) Assignee: SOLVAY SPECIALTY POLYMERS USA, LLC, Alpharetta, GA (US)

(21) Appl. No.: 18/681,472

(22) PCT Filed: Jul. 29, 2022
(86) PCT No.: PCT/EP2022/071360

§ 371 Date: Feb. 5, 2024

(30) Foreign Application Priority Data
Aug. 3, 2021 (EP) 21306080.9

(51) Int. Cl. C08G 69/26; C08K 3/04; C08K 3/22; C08K 5/5313; C08K 7/14; C08L 77/10

(52) U.S. Cl. CPC C08G 69/265; C08K 3/04; C08K 5/5313; C08K 7/14; C08L 77/10; C08G 2330/00; C08K 2003/2206; C08L 2205/22

(57) ABSTRACT

Described herein are polyamides (PA) formed from a reaction mixture (RM) including a diamine component (DA) and a dicarboxylic acid component (DC). The diamine component (DA) includes at least 99 mol % of 1.3-bis (aminomethyl) cyclohexane (“1,3-BAC”) and the dicarboxyic acid component (DC) includes at least 90 mol % of terephthalic acid (“TA”). It was surprisingly found that the polyamides (PA) had and increased glass transition temperature (“Tg”), while maintaining high melting temperatures (“Tm”) and high crystallinity. More particularly, in some embodiments, the polyamides (PA) have a Tg of at least 165° C. a Tm of at least 280° C. and a heat of fusion (“ΔHf”) of at least 20 J/g. Due at least in part to the relative high Tg, Tm and crystallinity (measured by ΔHf), the polyamides (PA) can be advantageously used in high heat application settings, while maintaining desirable mechanical, electrical properties and chemical resistance

The present application claims the priority of european patent application 21306080.9 filed on 3 Aug. 2021, the content of which being entirely incorporated herein by reference for all purposes. In case of any incoherency between the present application and the PCT application that would affect the clarity of a term or expression, it should be made reference to the present application only.

### FIELD OF THE INVENTION

The invention relates to polyamides having excellent thermal properties. The invention further relates to polymer compositions including the polyamides. Still further, the invention relates to articles including the polyamides or polyamide compositions.

### PROBLEM TO BE SOLVED

Polyphthalamides (“PPA”) have been commercially exploited for several decades now. They are particular excellent materials in applications wherein a combination of stiffness, strength and chemical resistance is needed. At room temperature, the performance of standard PPA-based materials is relatively good compared to other high performance polymers.

However, the temperature of use of any semi-crystalline polymer is dictated by its glass transition temperature which, in the case of PPA, is generally between 80° C. and 140° C. The strength, stiffness and other desirable properties such as electrical properties of PPA, however, deteriorate near the Tg, thus limiting its applicability. Formulating with stabilizers and other additives can improve their heat resistance only to a certain extent, but do not have any effect on mechanical and electrical performance at elevated temperature.

The invention aims at providing a new thermally resistant PPA with improved resistance which also exhibits good mechanical properties (e.g. tensile modulus and heat deflection temperature).

### BACKGROUND ART

GB 1383758A aims at preparing transparent polyamides and discloses a polyamide comprising (a) structural units derivable from an aromatic dicarboxylic acid having from 7 to 20 carbon atoms; (b) structural units derivable from an aliphatic saturated dicarboxylic acid having from 5 to 20 carbon atoms, the proportion of structural units derivable from the aliphatic dicarboxylic acid(s) being from 15 to 85 mol % of the total number of structural units derivable from dicarboxylic acids, and (c) structural units derivable from 1,3-bis-(amino-methyl)-cyclohexane. The polyamide of example 2 comprises 25 mol % of structural units derivable from terephthalic acid, is transparent (so not crystalline) and exhibits a second order temperature of only 138° C.

### SUMMARY OF INVENTION

In a first aspect, the invention is directed to a polyamide (PA) as disclosed below, notably in the set of claims.

The polyamide (PA) is formed from the reaction of monomers in a reaction mixture (RM). The reaction mixture (RM) includes a diamine component (DA) comprising at least 99.0 mol % of 1,3-bis (aminomethyl) cyclohexane (“1,3-BAC”), wherein mol % is relative to the total number of diamines in the diamine component; and a dicarboxylic acid component (DC) comprising generally from 90.0 mol % to 99.9 mol %, preferably from 90.0 mol % to 99.0 mol %, most preferably 90.0 mol % to 98.0 mol %, terephthalic acid (“TA”), wherein mol % is relative to the total number of dicarboxylic acids in the dicarboxylic acid component.

The polyamide (PA) exhibits a glass transition temperature (“Tg”) of at least 165° C., as measured according to ASTM D3418. The polyamide (PA) exhibits a melting temperature of at least 280° C., as measured according to ASTM D3418. The polyamide (PA) exhibits a heat of fusion (“ΔHf”) of at least 20.0 J/g, as measured according to ASTM D3418.

The diamine component (DA) is preferably free of aromatic diamines.

The dicarboxylic acid component (DC) may further include an aliphatic dicarboxylic acid or an aromatic dicarboxylic acid distinct from TA. In some embodiments, the aliphatic dicarboxylic acid is adipic acid and the aromatic dicarboxylic acid is isophthalic acid. In some embodiments, the dicarboxylic acid component (DC) includes both the aliphatic dicarboxylic acid and the aromatic dicarboxylic acid. The diamine component (DA) is preferably free of diamines other than 1,3-BAC.

In another aspect, the invention is directed to a polymer composition (PC) as disclosed below, notably in the set of claims. The polymer composition includes the polyamide (PA) and a component selected from the group consisting of reinforcing agents, tougheners, plasticizers, colorants, pigments, antistatic agents, dyes, lubricants, thermal stabilizers, light stabilizers, flame retardants, nucleating agents, antioxidants and any combination of two or more thereof. In some embodiments, the polymer composition (PC) includes a reinforcing agent selected from glass fiber and a carbon fiber. In some embodiments, the polymer composition (PC) includes a flame retardant, preferably a halogen free flame retardant.

In another aspect, the invention is direct to an article comprising the polyamide (PA) or the polymer composition (PC) as disclosed below, notably in the set of claims. In some embodiments, the article is selected from the group consisting of mobile electronics components, LED packaging, oil and gas components, food contact components, electrical and electronic device components, medical device components, construction components, industrial components, plumbing components, automotive parts, and aerospace parts. In some embodiments, the articles is an automotive component.

More details about these subject-matters are now given below.

### DETAILED DESCRIPTION OF THE INVENTION

Described herein are polyamides (PA) formed from a reaction mixture (RM) including a diamine component (DA) and a dicarboxylic acid component (DC). The diamine component (DA) includes at least 99.0 mol % of 1,3-bis(aminomethyl) cyclohexane (“1,3-BAC”) and the dicarboxylic acid component (DC) includes at least 90.0 mol % of terephthalic acid (“TA”). It was surprisingly found that the polyamides (PA) had an increased glass transition temperature (“Tg”), while maintaining high melting temperatures (“Tm”) and high crystallinity. The polyamides (PA) have a Tg of at least 165° C., a Tm of at least 280° C. and a heat of fusion (“ΔH_{f}”) of at least 20.0 J/g. Due at least in part to the relative high Tg, Tm and crystallinity (measured by ΔHf), the polyamides (PA) can be advantageously used in high heat application settings, while maintaining desirable mechanical, electrical properties and chemical resistance.

In the present application, any description, even though described in relation to a specific embodiment, is applicable to and interchangeable with other embodiments of the present disclosure. Furthermore where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list.

### The Polyamide (PA)

According to a 1^{st} aspect, the polyamide (PA) of the invention includes recurring unit (R_{PA1}) represented by the following formula:

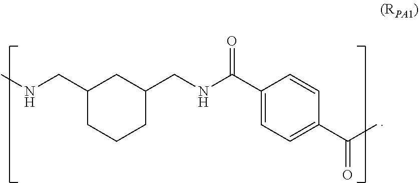

the proportion of recurring units (R_{PA1}) being between 90.0 mol % and 99.9 mol %, this proportion being relative to the total number of recurring units in the polyamide. The person of ordinary skill in the art will recognize that the recurring unit (R_{PA1}) is formed from the reaction (polycondensation) of the 1,3-BAC and TA.

As used herein and unless explicitly stated otherwise, mol % in reference to a recurring unit of a polymer (e.g. polyamide (PA)) is relative to the total number of recurring units in the indicated polymer (e.g. polyamide (PA)).

The polyamide (PA) may further include either or both recurring units (R_{PA2}) and (R_{PA3}), represented by the following formulae, respectively:

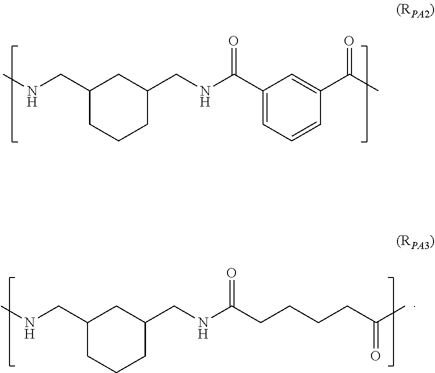

The proportion of recurring unit (R_{PA1}) may be no more than 99.0 mol %, no more than 98.0 mol %, no more than 97.0 mol %, no more than 96.0 mol % or no more than 95.5 mol % or no more than 95.0 mol %.

The proportion of recurring units (R_{PA1}) in the polyamide (PA) may more particularly be between 90.0 mol % and 99.0 mol % or between 90.0 mol % and 98.0 mol % or between 90.0 mol % and 96.0 mol %

In some embodiments including either recurring unit (R_{PA2}) or recurring unit (R_{PA3}) as the only additional recurring units, the proportion of the recurring units (either (R_{PA2}) or (R_{PA3}), as the case may be) may be at least 0.1 mol %. This proportion may be more particularly at least 1.0 mol %, at least 3.0 mol %, at least 4.0 mol % or at least 5.0 mol %. Furthermore, the proportion of the recurring units (either (R_{PA2}) or (R_{PA3}), as the case may be) may be no more than 10.0 mol % or no more than 8.0 mol %.

Still further, in some such embodiments, the proportion of recurring unit (either (R_{PA2}) or (R_{PA3}), as the case may be) may be from 0.1 mol % to 10.0 mol %, 1.0 mol % to 10.0 mol %, from 3.0 mol % to 10.0 mol %, from 5.0 mol % to 10.0 mol %, from 0.1 mol % to 8.0 mol %, from 1.0 mol % to 8.0 mol %, from 3.0 mol % to 8.0 mol % or from 5.0 mol % to 8.0 mol %.

In some embodiments in which the polyamide (PA) includes both recurring units (R_{PA2}) and (R_{PA3}), the proportion of each recurring unit (R_{PA2}) and (R_{PA3}) is independently selected from the ranges provided above. Of course, the total proportion of recurring units (R_{PA2}) and (R_{PA3}) is between 0.1 mol % to 10.0 mol %.

The invention more particularly relates to a polyamide (PA), the recurring units of which consist essentially or consist in recurring units (R_{PA1}) and (R_{PA2}); (R_{PA1}) and (R_{PA3}) or (R_{PA1}), (R_{PA2}) and (R_{PA3}).

According to a 2^{nd} aspect, the polyamide (PA) is such that its recurring units consist essentially or consist in recurring units (R_{PA1}) and (R_{PA2}) or (R_{PA1}) and (R_{PA3}), wherein the proportion of recurring units (R_{PA2}) or (R_{PA3}) is between 1.0 mol % and 11.0 mol %, more particularly between 3.0 mol % and 11.0 mol %, more particularly between 3.0 and 10.5 mol %.

This proportion may also be:
between 4.0 and 6.0 mol %; or
between 4.5 and 5.5 mol %; or
between 7.0 and 9.0 mol %; or
between 7.5 and 8.5 mol %; or
between 9.0 and 11.0 mol %; or
between 9.5 and 10.5 mol %.

According to a 3^{rd} aspect, the polyamide (PA) is such that its recurring units consist essentially or consist in recurring units (R_{PA1}), (R_{PA2}) and (R_{PA3}), wherein the proportion of each recurring unit (R_{PA2}) and (R_{PA3}) is independently selected in the ranges disclosed above, in particular for the 2^{nd} aspect, and the total proportion of recurring units (R_{PA2}) and (R_{PA3}) is at most 11.0 mol %, preferably at most 10.5 mol %.

Of course, for the polyamide (PA) according to the 2^{nd} and 3^{rd} aspect, the proportion of recurring units (R_{PA1}) corresponds to the remainder of the recurring units

### Number Average Molecular Weight (“Mn”)

The polyamide (PA) generally has a number average molecular weight (“Mn”) from 1,000 g/mol to 40,000 g/mol. Mn may be from 2,000 g/mol to 35,000 g/mol, from 4,000 to 30,000 g/mol, or from 5,000 g/mol to 20,000 g/mol. The number average molecular weight Mn can be determined by gel permeation chromatography (GPC) using ASTM D5296. The measurement of Mn can conveniently be performed in 1,1,1,3,3,3-hexafluoro-2-propanol. The calibration of the GPC can be performed with fully characterized polyphtalamide resins.

### Mechanical Properties

The polyamide (PA) of the invention exhibits interesting mechanical properties, such as a high tensile modulus at room temperature or at 180° C. and a high deflection temperature.

The polyamide (PA) of the invention may indeed exhibit a tensile modulus at room temperature of at least 4000 MPa, measured according to ISO 527. The tensile modulus is usually between 4000 and 4500 MPa.

The polyamide (PA) of the invention may exhibit a tensile modulus at 180° C. of at least 2500 MPa, measured according to ISO 527.

The polyamide (PA) of the invention may exhibit a heat deflection temperature at 1.8 MPa, measured according to ISO 75, of at least 150° C.

### Thermal Properties of the Polyamide of the Invention

As noted above, it was surprisingly found that the polyamide of the invention exhibits increased Tg, while maintaining high Tm and AHf, relative to analogous polyamides that are formed from a reaction mixture in which the diamine component has less than 99 mol % 1,3-BAC or the dicarboxylic acid component has less than 90 mol % TA.

### Glass Transition Temperature

The polyamide (PA) of the invetion exhibits a Tg of at least 165° C. The Tg of the polyamide (PA) may preferably be at least 175° C., at least 180° C., at least 190° C., at least 195° C. or at least 200° C.

The polyamide (PA) of the invention generally exhibits a Tg of no more than 250° C. The Tg may be no more than 240° C., no more than 230° C., no more than 230° C., no more than 220° C., no more than 210° C., nor more than 205° C.

The Tg may more particularly be from 165° C. to 250° C., from 175° C. to 250° C., from 180° C. to 250° C., from 190° C. to 250° C., from 195° C. to 250° C. or from 200° C. to 250° C. The Tg may also be from 165° C. to 240° C., from 175° C. to 240° C., from 180° C. to 240° C., from 190° C. to 240° C., from 195° C. to 240° C. or from 200° C. to 240° C. The Tg may be from 165° C. to 230° C., from 175° C. to 230° C., from 180° C. to 230° C., from 190° C. to 230° C., from 195° C. to 230° C. or from 200° C. to 230° C. The Tg may be from 165° C. to 220° C., from 175° C. to 220° C., from 180° C. to 220° C., from 190° C. to 220° C., from 195° C. to 220° C. or from 200° C. to 220° C.

Tg can be measured by Differential Scanning calorimetry (“DSC”) according to ASTM D3418, notably using a heating and cooling rate of 20° C./min.

Tg can more particularly be measured as described in the experimental section. Indeed, Tg can be measured by Differential Scanning calorimetry (“DSC”) according to ASTM D3418 using a heating and cooling rate of 20° C./min. Three scans are used for each DSC test: a first heat up to 350° C., followed by a first cool down to 30° C., followed by a second heat up to 360° C. The Tg is then determined from the second heat up.

### Melting Point (Tm)

The polyamide (PA) of the invention exhibits a Tm of at least 280° C. The Tm may preferably be at least 290° C., at least 300° C. or at least 310° C. The Tm is generally at most 340° C. or at most 330° C.

The Tm may be from 280° C. to 335° C., from 290° C. to 335° C., from 300° C. to 335° C., from 280° C. to 330° C., from 290° C. to 330° C. or from 300° C. to 330° C.

Tm can be measured by Differential Scanning calorimetry (“DSC”) according to ASTM D3418, notably using a heating and cooling rate of 20° C./min.

Tm can more particularly be measured as described in the experimental section. Indeed, Tm can be measured by Differential Scanning calorimetry (“DSC”) according to ASTM D3418 using a heating and cooling rate of 20° C./min. Three scans are used for each DSC test: a first heat up to 350° C., followed by a first cool down to 30° C., followed by a second heat up to 360° C. The Tm is then determined from the second heat up.

### Heat of Fusion

The polyamide (PA) of the invention is semi-crystalline.

The polyamide (PA) of the invention exhibits a ΔH_{f} of at least 20.0 J/g, at least 30.0 J/g, at least 35.0 J/g, at least 40.0 J/g or at least 50.0 J/g.

ΔH_{f} may be no more than 100.0 J/g, no more than 90.0 J/g or no more than 80.0 J/g.

ΔH_{f} may be from 20.0 J/g to 100.0 J/g, from 30.0 J/g to 100.0 J/g, from 35.0 J/g to 100.0 J/g, from 40.0 J/g to 100.0 J/g or from 50.0 J/g to 100.0 J/g. ΔH_{f} may be from 20.0 J/g to 90.0 J/g, from 30.0 J/g to 90.0 J/g, from 35.0 J/g to 90.0 J/g, from 40.0 J/g to 90.0 J/g or from 50.0 J/g to 90.0 J/g. ΔH_{f} may be from 20.0 J/g to 80.0 J/g, from 30.0 J/g to 80.0 J/g, from 35.0 J/g to 80.0 J/g, from 40.0 J/g to 80.0 J/g or from 50.0 J/g to 80.0 J/g.

ΔH_{f} can be measured by Differential Scanning calorimetry (“DSC”) according to ASTM D3418, notably using a heating and cooling rate of 20° C./min.

ΔH_{f} can more particularly be measured as described in the experimental section. Indeed, ΔH_{f} can be measured by Differential Scanning calorimetry (“DSC”) according to ASTM D3418 using a heating and cooling rate of 20° C./min. Three scans are used for each DSC test: a first heat up to 350° C., followed by a first cool down to 30° C., followed by a second heat up to 360° C.

As detailed above, the polyamide (PA) of the invention exhibits a combination of thermal properties. The invention thus more particularly relates to a polyamide (PA) comprising the recurring units (RPAI), the proportion of which being between 90.0 mol % to 99.9 mol %, this proportion being relative to the total number of recurring units in the polyamide, and exhibiting the following combination of thermal properties:
a Tg between 195° C. and 210° C.;
a Tm between 300° C. and 340° C.;
a ΔH_{f} of at least 30.0 J/g.

### Preparation of the Polyamide (PA)

The polyamide (PA) described herein can be prepared by any conventional method adapted to the synthesis of polyamides and polyphthalamides. The polyamide (PA) can be prepared by heating the monomers (e.g. the diamines and dicarboxylic acids) in the reaction mixture (RM) in the presence of less than 60 wt. % of water, preferentially less than 30 wt. %, less than 20 wt. %, less than 10 wt. %, preferentially with no added water. The temperature at which the mixture is heated must be high enough to induce the reaction between the amine groups and the carboxylic groups and to decrease the viscosity of the mixture. This temperature is generally at least 200° C. The polycondensation results in the formation of the amide bonds and the release of water as a by-product.

The reaction mixture preferably comprises a catalyst. The catalyst may be selected in the group consisting of phosphorous acid, ortho-phosphoric acid, meta-phosphoric acid, alkali-metal hypophosphite such as sodium hypophosphite and phenylphosphinic acid. A convenient catalyst used is phosphorous acid.

The polycondensation is advantageously performed in a well stirred vessel equipped with means to remove the volatile products of the reaction. As the viscosity of the reaction mixture increases over time, the stirrer is adapted to provide sufficient and efficient stirring to the reaction mixture at the beginning of the polymerization and when the conversion of the polycondensation is nearly complete.

The conditions disclosed in the experimental section may conveniently be used for the preparation of the polyamide (PA).

The polyamide (PA) may contain a chain limiter, which is a monofunctional molecule capable of reacting with the amine or carboxylic acid moiety, and is used to control the molecular weight of the polyamide. For example, the chain limiter can be acetic acid, propionic acid, benzoic acid and/or alkylamines with 6 to 12 carbon atoms. A stabilizer, such as a phosphite, may also be used.

The polyamide (PA) is formed from a reaction mixture (RM) including a diamine component (DA) and a dicarboxylic acid component (DC). The diamine component (DA) contains each diamine in the reaction mixture (RM) and the dicarboxylic acid component (DC) contains each dicarboxylic acid in the reaction mixture (RM). As used herein, and unless explicitly stated otherwise, mol % when referencing a diamine refers to the diamine concentration relative to all of the diamines in the diamine component (DA). Similarly, as used herein and unless explicitly stated otherwise, mol % when referencing a dicarboxylic acid refers to the dicarboxylic acid concentration relative to all of the dicarboxylic acids in the dicarboxylic acid component (DC).

### The Diamine COMPONENT (DA)

The diamine component (DA) includes at least 99.0 mol % of 1,3-BAC. In some embodiments, the diamine component (DA) includes at least 99.3 mol %, at least 99.5 mol %, at least 99.7 mol % or at least 99.9 mol % 1,3-BAC.

The diamine component (DA) may include other aliphatic diamines. Desirable aliphatic diamines include, but are not limited to, 1,2 diaminoethane; 1,2-diaminopropane; propylene-1,3-diamine; 1,3-diaminobutane; 1,4-diaminobutane; 1,5-diaminopentane; 2-methyl-1,5-diaminopentane; 1,6-diaminohexane (also called hexamethylenediamine); 3-methylhexamethylenediamine; 2,5-dimethylhexamethylenediamine; 2,2,4-trimethyl-hexamethylenediamine; 2,4,4-trimethyl-hexamethylenediamine; 1,7-diaminoheptane; 1,8-diaminooctane; 2,2,7,7-tetramethyloctamethylenediamine; 1,9-diaminononane; 2-methyl-1,8-diaminooctane; 5-methyl-1,9-diaminononane; 1,10-diaminodecane; 1,11-diaminoundecane; 1,12-diaminododecane; 1,13-diaminotridecane; 2,5-diamonotetrahydrofurane; and N,N-Bis(3-aminopropyl)methylamine. Other aliphatic diamines that are desireable include cycloaliphatic diamines including, but not limited to, isophorone diamine; 1,3-diaminocyclohexane; 1,4-diaminocyclohexane; bis-p-aminocyclohexylmethane; 1,4 bis(aminomethyl) cyclohexane; bis(4-amino-3-methylcyclohexyl) methane; and bis(4-aminocyclohexyl) methane.

Preferably, the diamine component is free of aromatic diamines. As used herein, “free of” a monomer(s) means that the total concentration of the indicated monomer(s) is less than 1.0 mol %, preferably less than 0.5 mol %, preferably less than 0.1 mol %, preferably less than 0.05 mol % or less than 0.01 mol %. For example, if the diamine component is free of aromatic diamines, it means that the total aromatic diamine concentration in the diamine component is less than 1.0 mol %, less than 0.5 mol %, less than 0.1 mol %, less than 0.05 mol % or less than 0.01 mol %. It follows from this that the recurring units of the polyamide (PA) do not contain a moiety derived from an aromatic diamine.

The diamine component (DA) is preferably free of any diamine other than 1,3-BAC.

The 1,3-BAC may have a cis trans ratio between 10/90 and 90/10, more particularly between 20/80 and 80/20 and even more particularly between 30/70 and 70/30. In some embodiments, 1,3-BAC has a cis/trans ratio comprised between 50/50 and 68/32 or between 50/50 and 75/25.

The higher the ratio, the higher the Tg. This is why the ratio would preferably be at least 50/50, or even at least 60/40.

### The Dicarboxylic Acid (DC) Component

The dicarboxylic acid component (DC) includes at least 90.0 mol % TA and less than 99.9 mol %. In some embodiments, additionally, the dicarboxylic acid component (DC) includes no more than 99 mol %, no more than 98 mol %, no more than 97 mol %, no more than 96 mol % or no more than 95.5 mol % or no more than 95 mol % TA. When the TA concentration approaches 100%, the Tm becomes undesirably high and requires even higher processing temperatures. Such high temperatures can lead to degradation of the polymer or polymer composition components during processing and can also lead to increased cycle times during part production.

In some embodiments, the dicarboxylic acid component includes other dicarboxylic acids. Desirable aliphatic dicarboxylic acids include, but are not limited to, oxalic acid; malonic acid; succinic acid; glutaric acid; 2,2 dimethyl glutaric acid; adipic acid; 2,4,4 trimethyl-adipic acid; pimelic acid; suberic acid; azelaic acid; sebacic acid; undecanedioic acid; dodecandioic acid; tridecanedioic acid; tetradecanedioic acid; pentadecanedioic acid; hexadecanedioic acid; and octadecanedioic acid. Other aliphatic dicarboxylic acides that are desirable include cycloaliphatic dicarboxylic acids including, but not limited to, 1,4-cyclohexane dicarboxylic acid.

Desirable aromatic dicarboxylic acids include, but are not limited to, isophthalic acid (“IA”); naphthalenedicarboxylic acids (e.g. naphthalene-2,6-dicarboxylic acid); 4,4′-bibenzoic acid; 2,5-pyridinedicarboxylic acid; 2,4-pyridinedicarboxylic acid; 3,5-pyridinedicarboxylic acid; 2,2-bis(4 carboxyphenyl)propane; 2,2-bis(4 carboxyphenyl)hexafluoropropane; 2,2-bis(4 carboxyphenyl) ketone; 4,4′-bis(4-carboxyphenyl) sulfone; 2,2-bis(3-carboxyphenyl)propane; 2,2-bis(3-carboxyphenyl)hexafluoropropane; 2,2-bis(3-carboxyphenyl)ketone; and bis(3-carboxyphenoxy)benzene.

In a preferable embodiment, the dicarboxylic acid component (DC) further includes either or both IA and adipic acid. In embodiment including either IA or adipic acid, the IA or adipic acid concentration is at least 1.0 mol %, at least.0 3 mol % or at least 5.0 mol %. Furthermore, in some such embodiments, the IA or adipic acid concentration is no more than 10.0 mol % or no more than 8.0 mol %. Still further, in some such embodiments, the IA or adipic concentration is from 1.0 mol % to 10.0 mol %, from 3.0 mol % to 10.0 mol %, from 5.0 mol % to 10.0 mol %, from 1.0 mol % to 8.0 mol %, from 3.0 mol % to 8.0 mol % or from 5.0 mol % to 8.0 mol %.

In an alternative preferable embodiment, the dicarboxylic acid component includes both IA and adipic acid. In some embodiment, the IA concentration and adipic concentration are each independently selected from the ranges given above. Of course, the total IA concentration and adipic acid concentration does not exceed 10.0 mol %.

In some of the preferable embodiments described above, the diamine component (DA) is free of diamines other than 1,3-BAC.

### The Polymer Composition (PC)

The polymer composition (PC) comprises the polyamide (PA) and one or more additional components. The proportion of polyamide (PA) in the polymer composition (PC) may be at least 30.0 wt. %, at least 40.0 wt. %, at least 50.0 wt. %, or at least 60.0 wt. %. As used herein and unless explicitly stated otherwise, the proportion of a component in the polymer composition (PC) is relative to the total weight of the polymer composition (PC).

The proportion of the polyamide (PA) in the polymer composition (PC) may be no more than 99.5 wt. %, no more than 99.0 wt. %, no more than 95.0 wt. %, no more than 90.0 wt. %, or no more than 80.0 wt. %.

The proportion of polyamide (PA) may be from 30.0 wt. % to 99.5 wt. %, from 40.0 wt. % to 99.5 wt. %, from 50.0 wt. % to 99.5 wt. % or from 60.0 wt. % to 99.5 wt. %. It may be from 30.0 wt. % to 99.0 wt. %, from 40.0 wt. % to 99.0 wt. %, from 50.0 wt. % to 99.0 wt. % or from 60.0 wt. % to 99.0 wt. %. It may be from 30.0 wt. % to 95.0 wt. %, from 40.0 wt. % to 95.0 wt. %, from 50.0 wt. % to 95.0 wt. % or from 60.0 wt. % to 95.0 wt. %. It may be from 30.0 wt. % to 90.0 wt. %, from 40.0 wt. % to 90.0 wt. %, from 50.0 wt. % to 90.0 wt. % or from 60.0 wt. % to 90.0 wt. %. It may be from 30.0 wt. % to 80.0 wt. %, from 40.0 wt. % to 80.0 wt. %, from 50.0 wt. % to 80.0 wt. % or from 60.0 wt. % to 80.0 wt. %.

The one or more additional component may be selected from the group consisting of reinforcing agents, tougheners, plasticizers, colorants, pigments, antistatic agents, dyes, lubricants, thermal stabilizers, light stabilizers, flame retardants (e.g. halogen free flame retardants), nucleating agents, antioxidants and any combination of two or more thereof. Examples of desirable halogen free flame retardants include, but are not limited to, metal dialkyl phosphinates (e.g. aluminum diethyl phosphinate), organophosphates (e.g. triphenylphosphates) and phosphonates (e.g. dimethyl methylphosphonates).

The polymer composition (PC) may comprise at least one reinforcing agent. The reinforcing agent may be in the form of fibers or fillers.

The reinforcing agent can be selected from fibrous and particulate reinforcing agents. A fibrous reinforcing filler is considered herein to be a material having length, width and thickness, wherein the average length is significantly larger than both the width and thickness. Generally, such a material has an aspect ratio, defined as the average ratio between the length and the largest of the width and thickness of at least 5, at least 10, at least 20 or at least 50. In some embodiments, the reinforcing fibers (e.g. glass fibers or carbon fibers) have an average length of from 3 mm to 50 mm. In some such embodiments, the reinforcing fibers have an average length of from 3 mm to 10 mm, from 3 mm to 8 mm, from 3 mm to 6 mm, or from 3 mm to 5 mm. In alternative embodiments, the reinforcing fibers have an average length of from 10 mm to 50 mm, from 10 mm to 45 mm, from 10 mm to 35 mm, from 10 mm to 30 mm, from 10 mm to 25 mm or from 15 mm to 25 mm. The average length of the reinforcing fibers can be taken as the average length of the reinforcing fibers prior to incorporation into the polymer composition (C) or can be taken as the average length of the reinforcing fiber in the polymer composition (C).

The reinforcing filler may be selected from mineral fillers (such as talc, mica, kaolin, calcium carbonate, calcium silicate, magnesium carbonate), glass fibers, carbon fibers, synthetic polymeric fibers, aramid fibers, aluminum fibers, titanium fibers, magnesium fibers, boron carbide fibers, rock wool fibers, steel fibers, wollastonite and any combination of two or more thereof.

Among fibrous fillers, glass fibers are preferred; they include chopped strand A-, E-, C-, D-, S-and R-glass fibers, as described in chapter 5.2.3, p. 43 48 of Additives for Plastics Handbook, 2^{nd} edition, John Murphy. Preferably, the filler is chosen from fibrous fillers. It is more preferably a reinforcing fiber that is able to withstand the high temperature applications.

In some embodiments, the total concentration of reinforcing agents is at least 15 wt. %, at least 20 wt. %, at least 25 wt. % or at least 30 wt. %. In some embodiments, the total concentration of reinforcing agents is no more than 65 wt. %, no more than 60 wt. %, no more than 55 wt. % or no more than 50 wt. %. In some embodiments, the total concentration of reinforcing agents is from 20 wt. % to 60 wt. % or from 30 wt. % to 50 wt. %.

In some embodiments, the polymer composition (PC) includes a toughener. A toughener is generally a low glass transition temperature (Tg) polymer, with a Tg for example below room temperature, below 0° C. or even below −25° C. As a result of its low Tg, the toughener is typically elastomeric at room temperature. Tougheners can be functionalized polymer backbones and are therefore reactive with other components of the polymer composition (PA).

The polymer backbone of the toughener can be selected from elastomeric backbones comprising polyethylenes and copolymers thereof, e.g. ethylene-butene; ethylene-octene; polypropylenes and copolymers thereof; polybutenes; polyisoprenes; ethylene-propylene-rubbers (EPR); ethylene-propylene-diene monomer rubbers (EPDM); ethylene-acrylate rubbers; butadiene-acrylonitrile rubbers, ethylene-acrylic acid (EAA), ethylene-vinylacetate (EVA); acrylonitrile-butadiene-styrene rubbers (ABS), block copolymers styrene ethylene butadiene styrene (SEBS); block copolymers styrene butadiene styrene (SBS); core-shell elastomers of methacrylate-butadiene-styrene (MBS) type, or mixture of one or more of the above. When the toughener is functionalized, the functionalization of the backbone can result from the copolymerization of monomers containing reactive functionalities or from the grafting of the polymer backbone with such reactive groups.

Specific examples of functionalized tougheners are notably terpolymers of ethylene, acrylic ester and glycidyl methacrylate, copolymers of ethylene and butyl ester acrylate; copolymers of ethylene, butyl ester acrylate and glycidyl methacrylate; ethylene-maleic anhydride copolymers; EPR grafted with maleic anhydride; styrene copolymers grafted with maleic anhydride; SEBS copolymers grafted with maleic anhydride; styrene-acrylonitrile copolymers grafted with maleic anhydride; ABS copolymers grafted with maleic anhydride.

In some embodiments, the toughener concentration is at least 1 wt. %, at least 2 wt. % or at least 3 wt. %. In some embodiments, the toughener concentration is no more than 30 wt. %, no more than 20 wt. %, no more than 15 wt. % or no more than 10 wt. %.

In some embodiments, the polymer composition (PC) includes one or more other conventional additives commonly used in the art, including plasticizers, colorants, pigments (e.g. black pigments such as carbon black and nigrosine), antistatic agents, dyes, lubricants (e.g. linear low density polyethylene, calcium or magnesium stearate or sodium montanate), thermal stabilizers, light stabilizers, flame retardants, nucleating agents and antioxidants.

In some embodiments, the polymer composition (PC) includes one or more other polymers, preferably polyamides different from the polyamide (PA). For example, in some embodiments, the polymer composition (PC) includes semi-crystalline or amorphous polyamides, such as aliphatic polyamides, semi-aromatic polyamides, and more generally the polyamides obtained by polycondensation between an aromatic or aliphatic saturated diacid and an aliphatic saturated or aromatic primary diamine, a lactam, an amino-acid or a mixture of these different monomers.

### Preparation of the Polymer Composition (PC)

The polymer compositions (PC) can be made with methods well known in the art. For example, the polymer composition (PC) can be made by melt-blending the polyamide (PA) and the specific components, e.g. a filler, a toughener, a stabilizer, and of any other desired components.

Any melt-blending method may be used for mixing polymeric ingredients and non-polymeric ingredients in the context of the present invention. For example, polymeric ingredients and non-polymeric ingredients may be fed into a melt mixer, such as single screw extruder or twin screw extruder, agitator, single screw or twin screw kneader, or Banbury mixer. The ingredients may be fed at once or gradual addition in batches. When the polymeric ingredient and non-polymeric ingredient are gradually added in batches, a part of the polymeric ingredients and/or non-polymeric ingredients is first added, and then is melt-mixed with the remaining polymeric ingredients and non-polymeric ingredients that are subsequently added, until an adequately mixed composition is obtained. If a reinforcing agent presents a long physical shape (for example, a long glass fiber), drawing extrusion molding may be used to prepare a reinforced composition.

### Articles and Applications

The polyamides (PA) and polymer compositions (PC) can be desirably incorporated into articles. In some embodiments, the article is selected from the group consisting of mobile electronics components, LED packaging, oil and gas components, food contact components, electrical and electronic device components, medical device components, construction components, industrial components, plumbing components, automotive parts, and aerospace parts.

In some embodiments, the article is a mobile electronic device component. As used herein, a “mobile electronic device” refers to an electronic device that is intended to be conveniently transported and used in various locations. A mobile electronic device can include, but is not limited to, a mobile phone, a personal digital assistant (“PDA”), a laptop computer, a tablet computer, a wearable computing device (e.g., a smart watch, smart glasses and the like), a camera, a portable audio player, a portable radio, global position system receivers, and portable game consoles.

In some embodiments, the mobile electronic device component is a radio antenna. In such embodiments, the radio antenna can be a WiFi antenna or an RFID antenna. The mobile electronic device component may also be an antenna housing.

In some embodiments, the mobile electronic device component is an antenna housing. In some such embodiments, at least a portion of the radio antenna is disposed on the polyamide (PA) or polymer composition (PC). Additionally or alternatively, at least a portion of the radio antenna can be displaced from the polyamide (PA) or polymer composition (PC). In some embodiments, the device component can be of a mounting component with mounting holes or other fastening device, including but not limited to, a snap fit connector between itself and another component of the mobile electronic device, including but not limited to, a circuit board, a microphone, a speaker, a display, a battery, a cover, a housing, an electrical or electronic connector, a hinge, a radio antenna, a switch, or a switchpad. In some embodiments, the mobile electronic device can be at least a portion of an input device.

Examples of electric and electronics devices are connectors, contactors and switches.

The polyamide (PA), polymer composition (PC) and article prepared therefrom may also be used as a gas barrier material for packaging applications, in mono or multilayer articles.

The polyamide (PA), polymer composition (PC) and article prepared therefrom can also be used in automotive applications. Examples of automotive components include, but are not limited to, components in thermal management systems (including, but not limited to, thermostat housings, water inlet/outlet valves, water pumps, water pump impellers, and heater cores and end caps), air management system components (including, but not limited to, turbocharger actuators, turbocharger by-pass valves, turbocharger hoses, EGR valves, CAC housings, exhaust gas recirculation systems, electronic controlled throttle valves, and hot air ducts), transmission components and launch device components (including, but not limited to, dual clutch transmissions, automated manual transmissions, continuously variable transmissions, automatic transmissions, torque convertors, dual mass flywheels, power takeoffs, clutch cylinders, seal rings, thrust washers, thrust bearings, needle bearings, and check balls), automotive electronic components, automotive lighting components (including, but not limited to, motor end caps, sensors, ECU housings, bobbins and solenoids, connectors, circuit protection/relays, actuator housings, Li-Ion battery systems, and fuse boxes), traction motor and power electronic components (including, but not limited to, battery packs), fuel and selective catalytic reduction (“SCR”) systems (including, but not limited to, SCR module housings and connectors, SCR module housings and connectors, fuel flanges, rollover valves, quick connects, filter housings, fuel rails, fuel delivery modules, fuel hoses, fuel pumps, fuel injector o-rings, and fuel hoses), fluid system components (e.g. fuels system components) (including, but not limited to inlet and outlet valves and fluid pump components), interior components (e.g. dashboard components, display components, and seating components), and structural and lightweighting components (e.g. gears and bearings, sunroofs, brackets and mounts, electrical battery housings, thermal management components, braking system elements, and pump and EGR systems).

The article can be molded from the polyamide (PA) or polymer composition (PC) of the present invention, by any process adapted to thermoplastics, e.g. extrusion, injection molding, blow molding, rotomolding or compression molding.

The article can be printed from the polyamide (PA) or polymer composition (PC) of the present invention, by a process comprising a step of extrusion of the material, which is for example in the form of a filament, or comprising a step of laser sintering of the material, which is in this case in the form of a powder.

### 3D Printing

The polyamide (PA) and polymer composition (PC) can be desirably incorporated into methods for manufacturing a three-dimensional (3D) object with an additive manufacturing system, comprising providing a part material comprising the polyamide (PA) or polymer composition (PC) of the present invention, and printing layers of the three-dimensional object from the part material.

The polyamide (PA) or polymer composition (PC) can therefore be in the form of a thread, a filament or a spool to be used in a process of 3D printing, e.g. Fused Filament Fabrication, also known as Fused Deposition Modelling (“FDM”).

The polyamide (PA) or polymer composition (PC) can also be in the form of a powder, for example a substantially spherical powder, to be used in a process of 3D printing, e.g. Selective Laser Sintering (“SLS”).

The polyamide (PA) or polymer composition (PC) can also be used for the manufacture of continuous fiber reinforced thermoplastics, with continuous fibers being selected from continuous carbon and continuous glass fibers.

### Experimental Section

The following examples demonstrate the thermal properties a good mechanical properties of the polyamides (PA) described herein.

The following raw materials were used to prepare the polymer samples: hexamethylenediamine (70wt %, from Ascend Performance Materials), 1,3-bis (aminomethyl) cyclohexane (from Mitsubishi Gas Chemical Company, cis/trans =68/32), terephthalic acid (from Flint Hills Resources, isophthalic acid (from Flint Hills Resources), adipic Acid (from Invista), acetic acid (from Sigma Aldrich) and phosphorus Acid (from Sigma Aldrich).

Preparation of the polyamides: this procedure outlines the synthesis of the polyamide samples described herein. All of the copolyamides were prepared according to a similar process in an autoclave reactor equipped with a distillate line fitted with a pressure control valve. As an example, polyamide E1 was prepared by charging into the reactor 354.6 grams of 1,3-bis(aminomethyl)cyclohexane, 383.7 grams of terephthalic acid, 20.2 grams of isophthalic acid, 410.2 grams of deionized water, 2.9 grams of glacial acetic acid and 0.2 gram of phosphorus acid. The reactor was sealed, purged with nitrogen and heated to 260° C. The steam generated was slowly released to keep the internal pressure at 120 psig. The temperature was then increased to 320° C. and, while keeping the reaction mixture at 320° C., the reactor pressure was slowly reduced to atmospheric within 45 minutes. After holding for an additional 20 min with nitrogen purging, the polymer was discharged from the reactor.

The following process was used to prepare larger quantities of copolyamides (preparation of polyamide E3 is described here as an example): a stirred batch vessel was charged with 24.8 kg deionized water, a diamine component consisting of 17.325 kg 1,3-bis(aminomethyl)cyclohexane and a dicarboxylic acid component consisting of 17.862 kg of terephthalic acid and 1.973 kg of isophthalic acid. The reactor was also charged with 10.4 g phosphorus acid and 144 g of glacial acetic acid. A salt solution was obtained by heating the above described mixture at 150° C. The contents were pumped continuously to a reactor zone maintained at about 185 psig and 220° C., then to a high pressure zone maintained at 300° C. and then through a tubular reactor maintained at 100 psig and 350° C. The melt was fed into a twin-screw extruder equipped with a forward vacuum vent. The finished polymer was extruded through a strand die into a water bath and chopped into pellets.

Tg, Tm and ΔH_{f} were measured by Differential Scanning calorimetry (“DSC”) according to ASTM D3418 using a heating and cooling rate of 20° C./min. Three scans were used for each DSC test: a first heat up to 350° C., followed by a first cool down to 30° C., followed by a second heat up to 360° C. The Tg, Tm and ΔH_{f} were determined from the second heat up. The results of thermal testing are displayed in Table 1.

TABLE 1

| | proportions | | | | | Thermal | | |
|---|---|---|---|---|---|---|---|---|
| | (mol %) | | proportions | | | Properties | | |
| | 1,3- | | (mol %) | | | Tg | Tm | ΔH_{f} |
| No. | BAC | HMDA | TA | IA | AA | (° C.) | (° C.) | (J/g) |
| E1 | 100 | | 95 | 5 | | 203 | 324 | 63 |
| E2 | 100 | | 92 | 8 | | 197 | 312 | 34 |
| E3 | 100 | | 90 | 10 | | 208 | 310 | 44 |
| E4 | 100 | | 90 | 5 | 5 | 189 | 306 | 34 |
| E5 | 100 | | 90 | | 10 | 191 | 329 | 37 |
| CE1 | 100 | | 85 | 15 | | 201 | 304 | 7 |
| CE2 | 100 | | 70 | 30 | | 196 | | * |
| CE3 | 35 | 65 | 100 | | | 161 | 322 | 45 |
| CE4 | 20 | 80 | 100 | | | 153 | 337 | 57 |
| CE5 | 20 | 80 | 95 | | 5 | 147 | 334 | 60 |
| CE6 | 15 | 85 | 85 | 15 | | 150 | 335 | 54 |
| CE7 | | 100 | 70 | 30 | | 137 | 320 | 50 |
| CE8 | 100 | | 100 | | | | 337 | 74 |

“*” crystallinity too low to be measured (amorphous)

Referring to Table 1, the samples formed from a diamine component having at least 99 mol % 1,3-BAC and a dicarboxylic acid component having from 90 mol % to 99.9 mol % TA (E1 to E5) had a Tg greater than 165° C., a Tm greater than 280° C. and a ΔHf of greater than 20 J/g. On the other hand, samples CE and CE2, formed with less than 90 mol % of TA in the dicarboxylic acid component, did not have desirable crystallinity (ΔHf less than 20 J/g), with CE2 being completely amorphous. Furthermore, while samples CE4 and CE5, formed with less than 99 mol % of 1,3-BAC in the diamine component, had desirable crystallinity (ΔH_{f} of at least 20 J/g), theses samples exhibited undesirably low Tg (less than 165° C.). Similar results were seen with samples CE6 and CE7, both of which were formed with less than 99 mol % 1,3-BAC in the diamine component and less than 90 mol % TA in the dicarboxylic acid component. Notably CE8 (TA concentration in the dicarboxylic acid component greater than 99.9 mol %) had undesirably high Tm, as explained in detail above.

The embodiments above are intended to be illustrative and not limiting. Additional embodiments are within the inventive concepts. In addition, although the present invention is described with reference to particular embodiments, those skilled in the art will recognized that changes can be made in form and detail without departing from the spirit and scope of the invention. Any incorporation by reference of documents above is limited such that no subject matter is incorporated that is contrary to the explicit disclosure herein.

### Evaluation of Mechanical Properties

The resins E3, E5 and CE7 were molded according to ISO 527 specifications using temperature of 220° C. The tensile properties were measured both at room temperature as well as at 180° C. The heat deflection temperature (HDT) for these samples were also measured according to ISO 75 standard. The results are shown in Table 2. Samples E3 and E5 showed higher tensile modulus both at RT and 180° C. as well as higher HDT compared to resin CE7.

TABLE 2

| Properties | E3 | E5 | CE7 |
|---|---|---|---|
| Tensile Modulus at | 4156 | 4360 | 3630 |
| room temperature | | | |
| (MPa) | | | |
| Tensile Modulus at | 3479 | 2566 | 409 |
| 180° C. | | | |
| (MPa) | | | |
| Heat Deflection | 210 | 195 | 133 |
| Temperature at 1.8 | | | |
| MPa | | | |

Compound formulations with resins E3 and CE7 were made using a Coperion ZSK-26 extruder. The components for each formulation were indicated in the Table 3 below. The tensile properties for the compounded samples were measured according to the ISO 527 standard. The compound 1 made with resin E3 showed better tensile properties than the compound 2 made with resin CE7.

TABLE 3

| Components (wt %) | Compound 1 | Compound 2 |
|---|---|---|
| E3 | 49.50 | |
| CE7 | | 49.50 |
| Carbon Black (CPTA- | 1.50 | 1.50 |
| 25759) | | |
| Exolit OP1230 | 15.00 | 15.00 |
| Glass fibers | 33.00 | 33.00 |
| other components | 1.00 | 1.00 |
| (LLDPE, CaO, | | |
| antioxidants) | | |
| Tensile Modulus (0.05%- | 12900 | 12000 |
| 0.25%) (MPa) | | |
| Tensile Strength @ Max | 170 | 143 |
| load (MPa) | | |
| Tensile Strain @ Max load | 2.1 | 1.8 |
| (%) | | |
| Tensile Stress @ Break (%) | 170 | 142 |
| Tensile Strain @ Break (%) | 2.1 | 1.8 |

1. A semi-crystalline polyamide (PA) comprising recurring units (R_{PA1}) of formula: 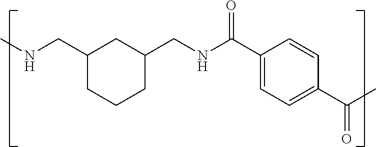
the proportion of recurring units (R_{PA1}) being between 90.0 mol % and 99.9 mol %, this proportion being relative to the total number of recurring units in the polyamide; and
exhibiting a melting temperature Tm of at least 280° C., as measured according to ASTM D3418.

2. (canceled)

3. (canceled)

4. (canceled)

5. (canceled)

6. (canceled)

7. (canceled)

8. (canceled)

9. A polyamide (PA) according to claim 1, comprising the recurring units (R_{PA1}) and either or both recurring units (R_{PA2}) and (R_{PA3}), represented by the following formulae, respectively:

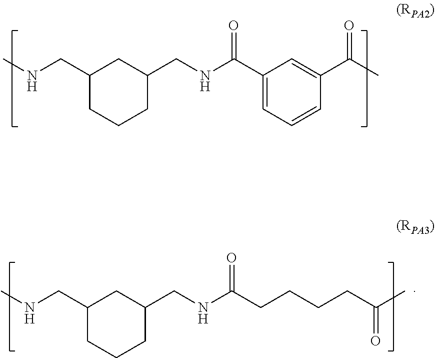

10. (canceled)

11. The polyamide (PA) according to claim 1, wherein the proportion of recurring units (R_{PA1}) is between 90.0 mol % and 99.0 mol %.

12. The polyamide (PA) according to aclaim 9 and including either recurring units (R_{PA2}) or recurring units (R_{PA3}) as the only additional recurring units, wherein the proportion of the recurring units (R_{PA2}) or (R_{PA3}) is at least 1.0 mol %; and/or no more than 10.0 mol %
where (R_{PA2}) and (R_{PA3}) are respectively of formula:

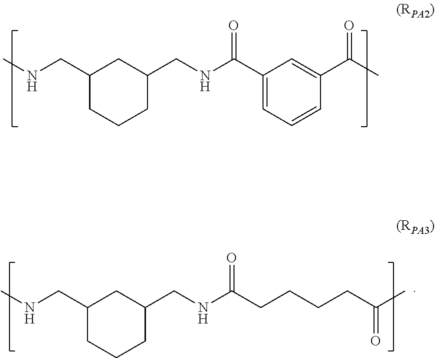

13. (canceled)

14. (canceled)

15. (canceled)

16. The polyamide (PA) according to claim 2 and including both recurring units (R_{PA2}) and recurring units (R_{PA3}) as the only additional recurring units, wherein the proportion of each recurring unit (R_{PA2}) and (R_{PA3}) is between 1.0 mol % and 10.0 mol %;
where (R_{PA2}) and (R_{PA3}) are respectively of formula:

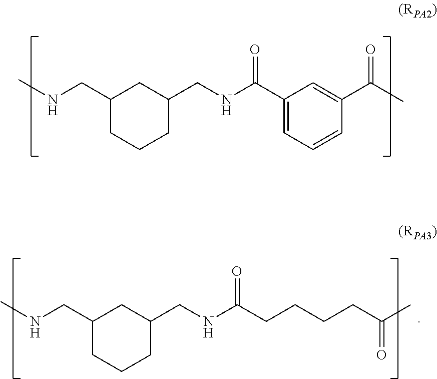

17. (canceled)

18. The polyamide (PA) according to claim 9, wherein the recurring units of the polyamide consist essentially of recurring units (R_{PA1}) and (R_{PA2}); (R_{PA1}) and (R_{PA3}) or (R_{PA1}), (R_{PA2}) and (R_{PA3}).

19. The polyamide (PA) according to claim 9, wherein the recurring units consist essentially of recurring units (R_{PA1}) and (R_{PA2});
(R_{PA1}) and (R_{PA3}) or (R_{PA1}), (R_{PA2}) and (R_{PA3}), 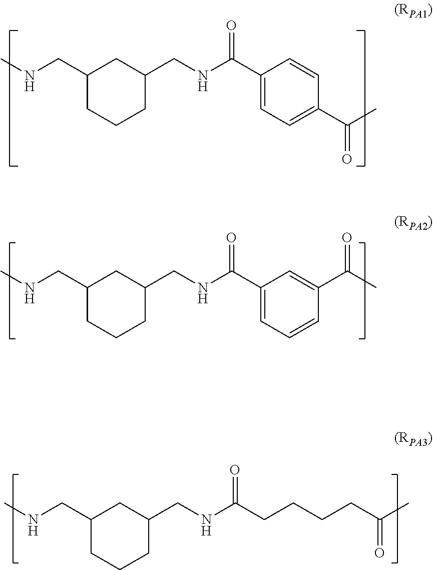
wherein:
for the polyamide with recurring units (R_{PA1}) and (R_{PA2}) or with recurring units (R_{PA1}) and (R_{PA3}), the proportion of recurring units (R_{PA2}) or (R_{PA3}) (as the case may be) is between 1.0 mol % and 11.0 mol %;
for the polyamide with recurring units (R_{PA1}), (R_{PA2}) and (R_{PA3}), the proportion of recurring units (R_{PA2}) is between 1.0 mol % and 11.0 mol %; the proportion of recurring units (R_{PA3}) is between 1.0 mol % and 11.0 mol %; and the total proportion of recurring units (R_{PA2}) and (R_{PA3}) is at most 11.0 mol %.

20. (canceled)

21. The polyamide (PA) of claim 1, wherein the polyamide (PA) exhibits a glass transition temperature (“Tg”) of at least 165° C., and/or at most 220° C. as measured according to ASTM D3418.

22. (canceled)

23. (canceled)

24. (canceled)

25. (canceled)

26. The polyamide (PA) according to claim 1, wherein the polyamide (PA) exhibits a melting temperature Tm of at most 340° C., as measured according to ASTM D3418.

27. (canceled)

28. (canceled)

29. The polyamide (PA) according to claim 1, wherein the polyamide (PA) exhibits a heat of fusion (“AH?”) of at least 20.0 J/g, as measured according to ASTM D3418.

30. (canceled)

31. The polyamide (PA) according to claim 1 exhibiting the following thermal properties, as measured according to ASTM D3418:
a Tg between 195° C. and 210° C.; and
a Tm between 300° C. and 340° C.; and
a ΔH_{f} of at least 30.0 J/g.

32. The polyamide (PA) of claim 1 wherein the moieties derived from 1,3-BAC in the recurring units have a cis/trans ratio between 10/90 and 90/10.

33. (canceled)

34. (canceled)

35. (canceled)

36. (canceled)

37. (canceled)

38. A polymer composition (PC) comprising:
the polyamide (PA) of claim 1 and
a component selected from the group consisting of reinforcing agents, tougheners, plasticizers, colorants, pigments, antistatic agents, dyes, lubricants, thermal stabilizers, light stabilizers, flame retardants, nucleating agents, antioxidants and any combination of two or more thereof.

39. (canceled)

40. (canceled)

41. (canceled)

42. An article comprising the polyamide (PA) of claim 1.

43. The article of claim 4214, wherein the article is selected from the group consisting of mobile electronics components, LED packaging, oil and gas components, food contact components, electrical and electronic device components, medical device components, construction components, industrial components, plumbing components, automotive parts, and aerospace parts.

44. (canceled)

45. An article comprising the polymer composition (PC) of claim 38.
